(19) United States
(12) Patent Application Publication
(10) Pub. No.: US 2024/0089682 A1
(43) Pub. Date: Mar. 14, 2024

(54) SIGNAL PROCESSING DEVICE, METHOD THEREOF, AND PROGRAM

(71) Applicant: SONY GROUP CORPORATION, TOKYO (JP)

(72) Inventor: YUKARA IKEMIYA, TOKYO (JP)

(21) Appl. No.: 17/754,733

(22) PCT Filed: Jul. 14, 2020
(86) PCT No.: PCT/JP2020/027511

§ 371 Date: Apr. 11, 2022

(30) Foreign Application Priority Data
Oct. 18, 2019 (JP) 2019-191005

(51) Int. Cl. H04S 7/00; H04R 29/00

(52) U.S. Cl. CPC H04S 7/30; H04R 29/002; H04R 2430/01; H04S 2400/13

(57) ABSTRACT

The present technology relates to a signal processing device, a method thereof, and a program capable of acquiring a characteristic of a plurality of speakers more easily. A signal processing device includes a correction value calculation unit configured to calculate, for every plurality of speakers having a substantially same emission characteristic, the speakers forming a speaker array, a gain correction value of each of the speakers on the basis of acoustic characteristic data acquired by collecting a sound from the speakers at a plurality of measurement points and the emission characteristic. The present technology is applicable to a measurement system.

### TECHNICAL FIELD

The present technology relates to a signal processing device, a method thereof, and a program, and especially relates to a signal processing device, a method thereof, and a program capable of acquiring a characteristic of a plurality of speakers more easily.

### BACKGROUND ART

Sound field control is a generic term for technologies for controlling a manner in which a sound is transmitted in a real space as intended by a user using a speaker array including a large number of synchronized speakers.

As a representative example of the sound field control, wavefront synthesis for the purpose of forming a desired wavefront, and local reproduction for the purpose of controlling sound pressure distribution are known.

Both the wavefront synthesis and local reproduction are implemented by reproducing, from each speaker, a reproduction signal in which a phase and a sound pressure are manipulated by complicated signal processing.

For example, the wavefront synthesis is a technology of specifying a wavefront desired to be created by the user and calculating a speaker drive signal so that the wavefront is synthesized as much as possible (refer to, for example, Non-Patent Document 1).

As a general application of the wavefront synthesis, for example, there is an application in which, by synthesizing a point sound source propagating from a certain point (virtual sound source) in a space, it is perceived as if a sound is output from the point even though there actually is no speaker at a position of the point.

In contrast, the local reproduction is a technology of specifying sound pressure distribution wanted to be implemented by the user, and calculating the speaker drive signal so that the distribution is implemented as much as possible (refer to, for example, Non-Patent Document 2).

As a general application of such local reproduction, for example, there is an application of implementing reproduction in which a sound is heard loud only in a certain viewing area by increasing a sound pressure in a certain area in a space and decreasing the sound pressure in other areas.

Note that, in the local reproduction, the area in which the sound pressure is increased is referred to as a bright area, and the area in which the sound pressure is decreased is referred to as a dark area.

### CITATION LIST

### Non-Patent Document

Non-Patent Document 1: A. J. Berkhout, D. de Vries, P. Vogel: “Acoustic Control by Wave Field Synthesis”, J. Acoust. Soc. Am., 1993
Non Patent Document 2: Joung-Woo Choi and Yang-Hann Kim, “Generation of an acoustically bright zone with an illuminated region using multiple sources”, J. Acoust. Soc. Am., 2002.

### SUMMARY OF THE INVENTION

### Problems to be Solved by the Invention

By the way, in a case where sound field control is performed, a reproduction signal is calculated supposing that a sound volume and a speaker emission characteristic of each of a plurality of speakers are known.

However, in a practical situation, there is a case where the sound volume for each frequency of a sound (reproduction signal) output from each speaker is different depending on sound volume setting of an amplifier and a difference in frequency characteristic for each speaker. Furthermore, a sound volume difference between the speakers also changes over time. Moreover, it is often the case that the speaker emission characteristic of the speaker is not measured in advance and unknown.

Variation in sound volume of each speaker and a difference in speaker emission characteristic between the time of calculation and the time of reproduction of the reproduction signal significantly deteriorates accuracy of sound field control, so that it is necessary to correct them correctly.

However, in a scene in which a large number of speakers are used, it is necessary to perform acoustic measurement by moving and installing a microphone many times in order to individually measure the sound volume and the speaker emission characteristic of each speaker, which takes an enormous amount of time.

Furthermore, in a case where a plurality of microphones is used for shortening time, there is a case where a difference in sensitivity and frequency characteristic between the microphones affects a measurement result, and accurate measurement cannot be performed.

The present technology is achieved in view of such a situation, and an object thereof is to more easily acquire a characteristic of a plurality of speakers.

### Solutions to Problems

A signal processing device according to an aspect of the present technology includes a correction value calculation unit configured to calculate, for every plurality of speakers having substantially the same emission characteristic, the speakers forming a speaker array, a gain correction value of each of the speakers on the basis of acoustic characteristic data acquired by collecting a sound from the speakers at a plurality of measurement points and the emission characteristic.

A signal processing method or a program according to an aspect of the present technology includes calculating, for every plurality of speakers having substantially the same emission characteristic, the speakers forming a speaker array, a gain correction value of each of the speakers on the basis of acoustic characteristic data acquired by collecting a sound from the speakers at a plurality of measurement points and the emission characteristic.

According to an aspect of the present technology, for every plurality of speakers having substantially the same emission characteristic, the speakers forming a speaker array, a gain correction value of each of the speakers is calculated on the basis of acoustic characteristic data acquired by collecting a sound from the speakers at a plurality of measurement points and the emission characteristic.

### BRIEF DESCRIPTION OF DRAWINGS

FIG. 1 is a diagram for illustrating measurement of a characteristic of a speaker.

FIG. 2 is a diagram for illustrating the measurement of the characteristic of the speaker.

FIG. 3 is a diagram for illustrating post-processing.

FIG. 4 is a diagram for illustrating mapping of sound pressure information.

FIG. 5 is a diagram for illustrating generation of correction data for sound volume variation.

FIG. 6 is a diagram for illustrating the generation of the correction data for the sound volume variation.

FIG. 7 is a diagram illustrating a configuration example of a measurement system.

FIG. 8 is a flowchart for illustrating measurement processing.

FIG. 9 is a flowchart for illustrating the measurement processing.

FIG. 10 is a diagram for illustrating a configuration example of a computer.

### MODE FOR CARRYING OUT THE INVENTION

An embodiment to which the present technology is applied is hereinafter described with reference to the drawings.

### First Embodiment

<Regarding Present Technology>

The present technology corrects, by utilizing a fact that a speaker emission characteristic of each speaker unit (hereinafter, simply referred to as a speaker) forming a multi-channel speaker array does not significantly change, a variation in sound volume of each speaker by measurement by moving and installing a microphone the smallest possible number of times.

That is, a test signal from each speaker of the speaker array is measured by the microphone installed at a certain measurement point (position). Then, on the assumption that each speaker has the same speaker emission characteristic, measurement data of each speaker is regarded as the measurement data regarding one speaker, and the sound volume is estimated. Furthermore, the speaker emission characteristic of the speaker is also estimated as necessary.

This makes it possible to acquire the variation in sound volume, that is, a characteristic regarding the sound volume, and the speaker emission characteristic of each speaker of the multi-channel speaker array with a small number of times of installation and movement of the microphone, that is, in a short measurement time. In this case, assuming that the speaker emission characteristic of each speaker is bilaterally symmetrical, an operation amount may be further reduced.

In a system to which the present technology is applied, the sound volume variation and the speaker emission characteristic of each speaker are estimated (acquired) from the measurement data measured by one or more microphones for the speaker array including a plurality of speakers.

Here, the measurement data at least includes microphone position information, speaker direction information, and acoustic characteristic data.

That is, the microphone position information is information indicating a relative position of the microphone, that is, the measurement point as seen from the speaker at the time of measurement.

Furthermore, the speaker direction information is information indicating a front direction of the speaker at the time of measurement, more specifically, information indicating the direction of the microphone (measurement point) with respect to the front direction of the speaker.

The acoustic characteristic data is data including sound pressure information generated by recording (collecting) the test signal reproduced from each speaker by each microphone and appropriately performing post-processing.

When acquiring such measurement data including the microphone position information, the speaker direction information, and the acoustic characteristic data, the microphone is installed sufficiently near the speaker array.

Then, the test signal is reproduced by each speaker forming the speaker array, the test signal is recorded (collected) by the microphone, and the post-processing is performed on data acquired by recording as necessary, so that the measurement data is acquired.

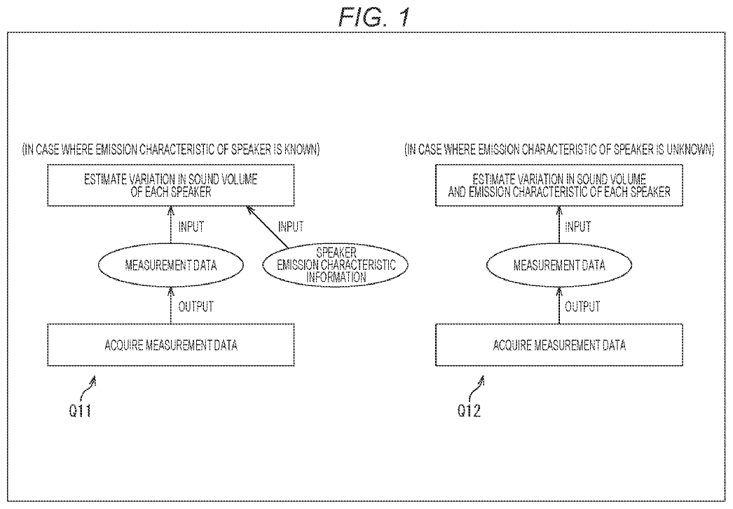

Furthermore, in addition to such measurement data, for example, a case where the speaker emission characteristic information is acquired and a case where the speaker emission characteristic information is not acquired are considered as illustrated in FIG. 1. In other words, a case where the speaker emission characteristic of each speaker is known and a case where this is unknown are considered.

Here, the speaker emission characteristic information is information indicating the speaker emission characteristic common among the speakers forming the multi-channel speaker array.

As indicated by an arrow Q11 in FIG. 1, in a case where the speaker emission characteristic information is acquired, the speaker emission characteristic information and the measurement data acquired by the measurement are used to estimate the sound volume variation of each speaker forming the speaker array.

In contrast, as indicated by an arrow Q12, in a case where the speaker emission characteristic information is not acquired, the measurement data acquired by the measurement is used to estimate both the sound volume variation and the speaker emission characteristic of each speaker forming the speaker array.

Next, the acquisition of the measurement data and the estimation of the sound volume variation and the speaker emission characteristic of each speaker are described more specifically.

First, the acquisition of the measurement data is described.

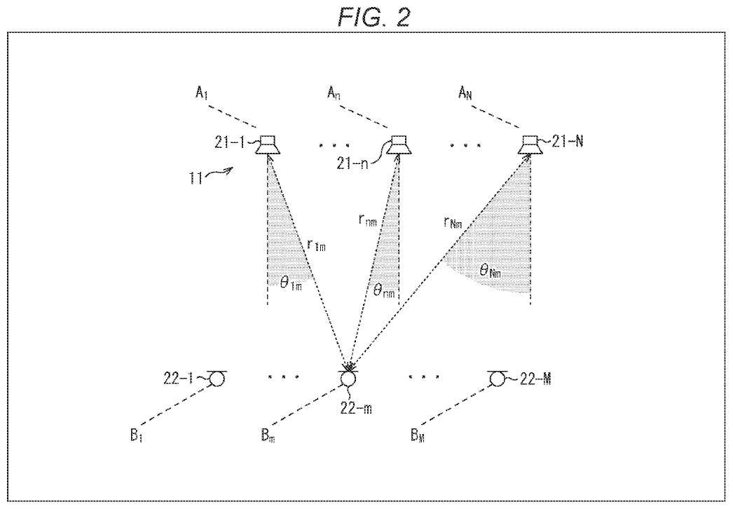

For example, as illustrated in FIG. 2, it is supposed that, in order to use a multi-channel speaker array 11 for sound field control, calibration of the sound volume variation of each speaker forming the speaker array 11 is performed.

The speaker array 11 is a linear speaker array including N speakers including a speaker 21-1, a speaker 21-n (where 1≤n≤N), and a speaker 21-N. Here, it is supposed that the N speakers 21-1 to 21-N have substantially the same speaker emission characteristic.

In this example, the speaker 21-1 is installed (arranged) at an installation position A₁, the speaker 21-n is installed at an installation position Aₙ, and the speaker 21-N is installed at an installation position A_{N}.

Note that, hereinafter, in a case where it is not necessary to particularly distinguish the speakers 21-1 to 21-N from one another, they are sometimes simply referred to as the speakers 21. Furthermore, hereinafter, in a case where it is not necessary to particularly distinguish the installation positions A₁ to A_{N} from one another, they are sometimes simply referred to as the installation positions A.

Moreover, here, M microphones including a microphone 22-1 installed at an installation position B₁, a microphone 22-m (where 1≤m≤M) installed at an installation position Bₘ, and a microphone 22-M installed at an installation position B_{M} are installed in front of the speaker array 11. Then, it is supposed that the microphones 22-1 to 22-M are used for the calibration of the speaker array 11.

In this example, the M microphones 22-1 to 22-M are linearly arranged to be installed in front of the speaker array 11.

Note that, hereinafter, in a case where it is not necessary to particularly distinguish the microphones 22-1 to 22-M from one another, they are sometimes simply referred to as the microphones 22. Furthermore, hereinafter, in a case where it is not necessary to particularly distinguish the installation positions B₁ to B_{M} from one another, they are sometimes simply referred to as the installation positions B.

Moreover, here, in order to simplify the description, an example in which the M microphones 22 are installed at M desired measurement points (installation positions B) is described; however, it is also possible to sequentially install one microphone 22 at M installation positions B while moving the same and perform the measurement.

Now, it is supposed that a positional relationship between each speaker 21 and the microphone 22 and the front direction of each speaker 21, that is, the direction of the speaker 21 are known.

In such a case, when each speaker 21 reproduces a sound having a predetermined characteristic as a test signal, and the microphone 22 collects (records) the test signal, recorded sound data, a measurement angle θₙₘ, and a measurement distance rₙₘ corresponding to each speaker 21 are acquired.

Here, the recorded sound data regarding the speaker 21 is an audio signal acquired by collecting the test signal output from one speaker 21 by one microphone 22.

Furthermore, the measurement angle θₙₘ is an angle of a direction of any m-th microphone 22-m from the front direction of any n-th speaker 21-n. That is, the measurement angle θₙₘ is an angle indicating the direction of the microphone 22-m with respect to the front direction of the speaker 21-n.

Specifically, when a straight line connecting the installation position A n of the speaker 21-n and the installation position B m of the microphone 22-m is set to Lₙₘ, an angle between the straight line L nm and the front direction of the speaker 21-n is the measurement angle θₙₘ.

Moreover, the measurement distance rₙₘ is a distance from any n-th speaker 21-n to any m-th microphone 22-m, that is, a length of the straight line L nm.

When measuring the measurement data, for all combinations of the speaker 21 and the microphone 22, the test signal is output from one speaker 21, and the test signal is collected by each microphone 22, so that the recorded sound data, the measurement angle θₙₘ, and the measurement distance rₙₘ are acquired.

The acoustic characteristic data is generated from the recorded sound data acquired in this manner.

Furthermore, the measurement angle θₙₘ is the speaker direction information, and information indicating the position of the microphone 22-m including the measurement angle θₙₘ and the measurement distance rₙₘ, that is, information indicating the position of the measurement point of the test signal is the microphone position information.

For example, a time stretched pulse (TSP) signal, white noise, pink noise and the like are considerable as an example of the test signal output from the speaker 21.

Furthermore, in a space in which the speaker array 11 and the microphone 22 are installed, there is a case where the test signal is reflected by a wall, a floor and the like, and not only a direct sound of the test signal but also a reflected sound of the test signal are recorded by the microphone 22.

Therefore, the post-processing may be performed on the recorded sound data so that an influence of the reflected sound and the like is suppressed and the recorded sound data derived only from the direct sound from the speaker 21 may be acquired.

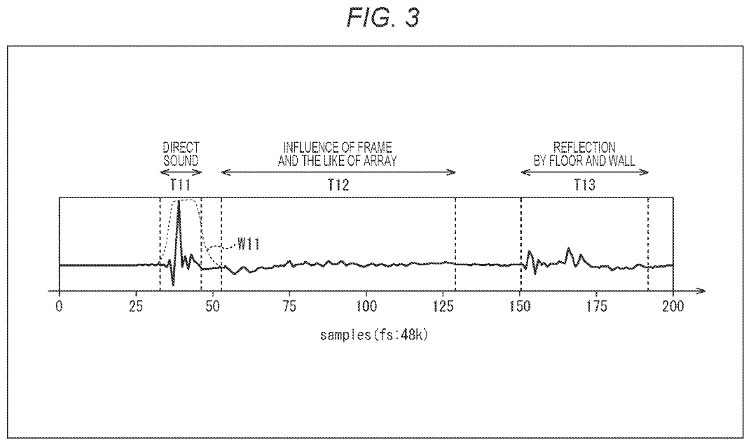

Specifically, for example, it is supposed that a signal having a time waveform illustrated in FIG. 3 is acquired as the recorded sound data. Note that, in FIG. 3, a level is plotted in a longitudinal direction and time (sample) is plotted in a lateral direction.

In this example, for example, a predetermined section T11 in a first half of the recorded sound data is a section including the direct sound of the test signal.

In contrast, a section T12 of the recorded sound data is a section including a component generated by an influence of a frame (casing) and the like for fixing each speaker 21 forming the speaker array 11, and a section T13 is a section including the reflected sound generated by the reflection of the test signal by the floor and the wall.

Therefore, for example, cutout processing based on a cutout window indicated by a curve W11 may be performed on the recorded sound data as the post-processing.

In this manner, in the example illustrated in FIG. 3, a portion of the section T11 of the recorded sound data is cut out by the cutout window, and the recorded sound data including only the component of the direct sound of the test signal may be acquired. In other words, it is possible to remove unnecessary components such as the reflected sound other than the direct sound included in a latter half of the recorded sound data.

The above-described acoustic characteristic data is generated from the recorded sound data appropriately subjected to the post-processing in this manner.

Here, for example, it is supposed that acoustic characteristic data generated on the basis of the recorded sound data acquired by collecting the test signal reproduced by the n-th speaker 21-n by the m-th microphone 22-m and appropriately performing the post-processing is represented by dₙₘ.

Note that, as the acoustic characteristic data dₙₘ, a case where one data is generated for the speaker 21, that is, a case where pieces of information of all frequency bands are collected into one data, and a case where information for each frequency is individually generated are considerable.

For example, as an example in which the pieces of information of all the frequency bands are collected into one acoustic characteristic data dₙₘ, it is conceivable to calculate an average sound pressure from the recorded sound data and set a piece of acquired sound pressure information (sound pressure) as the acoustic characteristic data dₙₘ.

In contrast, as an example of a case where the acoustic characteristic data dₙₘ has information for each frequency individually, for example, it is conceivable to set sound pressure information (sound pressure) of each frequency bin acquired by performing discrete Fourier transform on the recorded sound data as the acoustic characteristic data dₙₘ.

Furthermore, on the basis of the measurement distance rₙₘ, correction processing of correcting distance attenuation generated between the speaker 21 and the microphone 22 is performed on the sound pressure information as the acoustic characteristic data dₙₘ. Specifically, for example, the sound pressure information is multiplied by a coefficient proportional to the measurement distance rₙₘ.

When the measurement data including the acoustic characteristic data dₙₘ, the measurement angle θₙₘ, and the measurement distance rₙₘ is acquired in the above-described manner, the sound volume variation and the speaker emission characteristic of each speaker 21 are estimated on the basis of the measurement data.

Specifically, for example, it is regarded that the sound pressure information included in each acoustic characteristic data dₙₘ is acquired for one speaker 21.

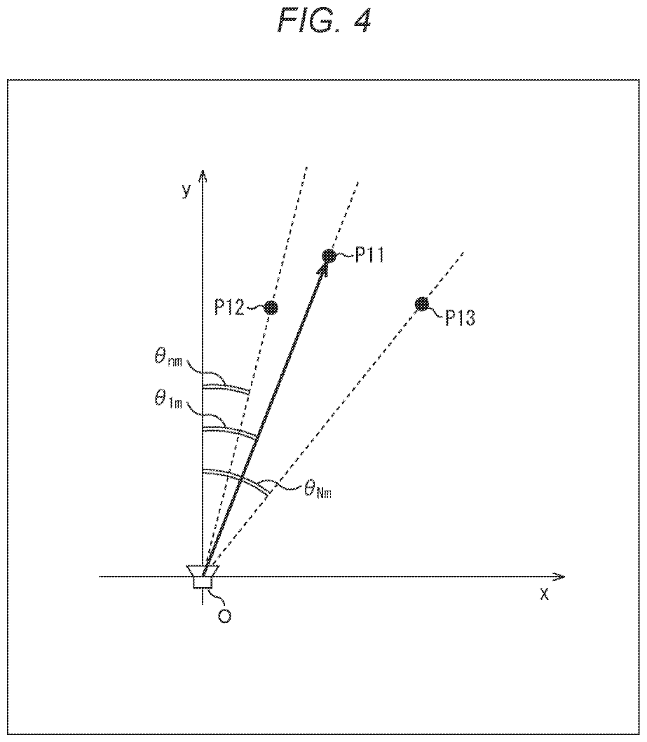

Then, each acoustic characteristic data dₙₘ, that is, the sound pressure information is mapped at a point (position) corresponding to the measurement angle θₙₘ and the sound pressure information in a coordinate system (hereinafter, also referred to as an emission characteristic coordinate system) capable of expressing the speaker emission characteristic of the speaker 21 as illustrated in FIG. 4, for example.

In FIG. 4, a two-dimensional xy coordinate system including an x-axis and a y-axis is an emission characteristic coordinate system.

In this emission characteristic coordinate system, a direction of each point (position) as seen from an origin O is a direction as seen from the speaker 21, that is, a direction based on the front direction of the speaker 21, and here, a y-axis direction is the front direction of the speaker 21. Furthermore, in the emission characteristic coordinate system, a distance from the origin O to each point (position) indicates magnitude of the sound pressure information. Note that, hereinafter, it is described supposing that the speaker emission characteristic of each speaker 21 is bilaterally symmetrical.

In this example, for example, the sound pressure information included in acoustic characteristic data dim acquired for the combination of the speaker 21-1 and the microphone 22-m illustrated in FIG. 2 is mapped (arranged) at a position P11.

Here, the position P11 is a position (point) on the emission characteristic coordinate system determined by the sound pressure information of a measurement angle θ₁ₘ and the acoustic characteristic data dim acquired for the combination of the speaker 21-1 and the microphone 22-m.

Specifically, an angle between a direction of the position P11 as seen from the origin O of the emission characteristic coordinate system, that is, a straight line connecting the origin O and the position P11 and the y-axis is the measurement angle θ₁ₘ.

Furthermore, a distance from the origin O to the position P11 is the magnitude of the sound pressure information (sound pressure) of the acoustic characteristic data dim. That is, in the emission characteristic coordinate system, the distance from the origin O indicates the magnitude of the sound pressure, more specifically, an absolute value of the sound pressure information.

Moreover, for example, the sound pressure information included in the acoustic characteristic data dₙₘ acquired for the combination of the speaker 21-n and the microphone 22-m is mapped at a position P12, and the sound pressure information included in acoustic characteristic data d_{Nm} acquired for the combination of the speaker 21-N and the microphone 22-m is mapped at a position P13.

The position P12 and the position P13 are positions determined in a manner similar to that of the position P11. That is, the position P12 is the position determined by the measurement angle θₙₘ and the acoustic characteristic data dₙₘ, and the position P13 is the position determined by a measurement angle θ_{Nm} and the acoustic characteristic data d_{Nm}.

When the sound pressure information of each acoustic characteristic data dₙₘ is mapped on the emission characteristic coordinate system in this manner, the sound volume variation of each speaker 21 and the speaker emission characteristic common to all the speakers 21 are estimated on the basis of a mapping result.

Note that, in a case where the speaker emission characteristic is known, that is, in a case where the speaker emission characteristic information is acquired in advance, only the sound volume variation of the speaker 21 is estimated.

First, a case where the speaker emission characteristic is known, that is, a case where the speaker emission characteristic information is acquired in advance and only the sound volume variation of each speaker 21 is estimated is described.

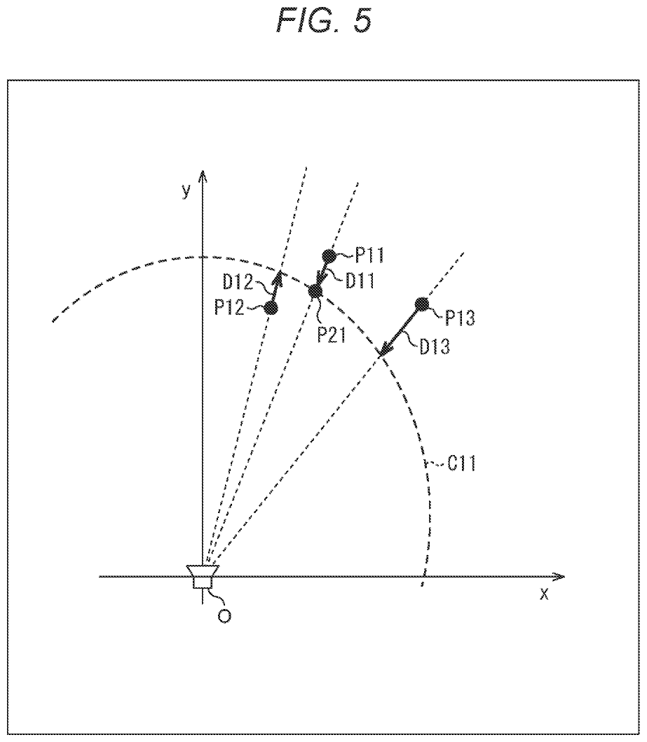

In this case, for example, as illustrated in FIG. 5, the speaker emission characteristic indicated by the speaker emission characteristic information of the speaker 21 is further mapped to the mapping result of the acoustic characteristic data dₙₘ to the emission characteristic coordinate system. Note that, in FIG. 5, the same reference sign is assigned to a portion corresponding to that in FIG. 4 and the description thereof is omitted.

In the example in FIG. 5, the speaker 21 is virtually arranged at the origin O of the emission characteristic coordinate system so that the front direction of the speaker 21 is the y-axis direction (+y direction).

Then, with respect to such arrangement of the speaker 21, the sound pressure serving as a predetermined reference is set to a reference sound pressure, and the speaker emission characteristic indicated by the speaker emission characteristic information is mapped on the emission characteristic coordinate system on the basis of the reference sound pressure.

Here, a curve C11 indicates the speaker emission characteristic indicated by the speaker emission characteristic information, that is, the sound pressure showing an emission pattern of the sound in each direction from the speaker 21.

Note that, a value of the reference sound pressure may be a value determined in advance, or may be determined by calculation and the like based on the acoustic characteristic data dₙₘ acquired for each speaker 21.

When the speaker emission characteristic is mapped in this manner, for each direction as seen from the origin O, that is, each measurement angle θₙₘ, a difference between the sound pressure information of the acoustic characteristic data dₙₘ and the sound pressure indicated by the speaker emission characteristic in the same direction, that is, a sound volume difference is acquired.

Then, on the basis of the sound volume difference acquired for each direction as seen from the origin O on the emission characteristic coordinate system, correction data for correcting the sound volume variation (variation in sound pressure) of the corresponding speaker 21 is generated.

Specifically, for example, an intersection between a straight line connecting the origin O and the position P11 and the curve C11 is set as a position P21. At that time, the magnitude of the sound pressure (sound volume difference) indicated by an arrow D11 from the position P11 to the position P21 is made an estimation result of the sound volume variation for the measurement angle θ₁ₘ of the speaker 21-1 corresponding to the position P11.

In a case where the speaker 21-1 outputs the test signal, the sound pressure indicated by the position P21 should be essentially acquired as the measurement result in the direction corresponding to the measurement angle θ₁ₘ, but the sound pressure indicated by the position P11 is actually acquired as the measurement result. Therefore, it may be understood that the variation occurs by the sound volume difference indicated by the arrow D11.

From such estimation result of the sound volume variation for the measurement angle θ₁ₘ of the speaker 21-1, the sound volume variation for other measurement angles of the speaker 21-1 may also be estimated.

For example, at the time of actual sound field control, when correction is performed by the sound volume difference indicated by the arrow D11 on the reproduction signal for the measurement angle θ₁ₘ, the sound pressure of the reproduction signal output from the speaker 21-1 should become the sound pressure indicated by the position P21. That is, the sound volume variation should be corrected.

In the present technology, the correction data for correcting the sound volume variation of the speaker 21-1, that is, the sound pressure (sound volume) of the reproduction signal output from the speaker 21-1 is generated on the basis of the estimation result of the sound volume variation for the speaker 21-1 acquired in this manner.

In other words, the correction data for correcting a gain of the reproduction signal, that is, a gain of a speaker drive signal for outputting the reproduction signal from the speaker 21-1 is generated.

Note that, it is only required that, depending on whether the sound pressure information is generated for each frequency bin as the acoustic characteristic data dₙₘ, a piece of sound pressure information is generated for all the frequency bands or the like, the correction data for each frequency bin is generated or one correction data is generated for all the frequency bands.

Furthermore, as for the speaker 21-n, the sound volume difference indicated by the arrow D12 is acquired as the estimation result of the sound volume variation of the measurement angle θₙₘ, and the correction data for correcting the sound volume variation of the speaker 21-n is generated on the basis of the estimation result.

Similarly, as for the speaker 21-N, the sound volume difference indicated by the arrow D13 is acquired as the estimation result of the sound volume variation of the measurement angle θ_{Nm}, and the correction data for correcting the sound volume variation of the speaker 21-N is generated on the basis of the estimation result.

As described above, the sound volume variation of each speaker 21 is estimated with reference to the mapping result of the speaker emission characteristic common to all the speakers 21, and the correction data is generated for each speaker 21 on the basis of the estimation result.

In this manner, it is possible to easily estimate the sound volume variation, which is the characteristic regarding the sound volume of each speaker 21, and correct the sound volume variation generated between the speakers 21.

For example, in a case where there is no sound pressure information as a reference as the mapping result of the speaker emission characteristic, it is not easy to estimate the sound volume variation between a plurality of speakers 21 or correct the sound volume variation between the speakers 21.

In contrast, in the present technology, on the assumption that all the speakers 21 of the speaker array 11 have the same speaker emission characteristic, it is possible to easily acquire the correction data for correcting the sound volume variation between the respective speakers 21 with respect to the mapping result of the speaker emission characteristic.

In contrast, in a case where the speaker emission characteristic information is not acquired in advance, that is, in a case where the speaker emission characteristic of each speaker 21 is unknown, the speaker emission characteristic of each speaker 21 is first estimated in order to estimate the sound volume variation of each speaker 21.

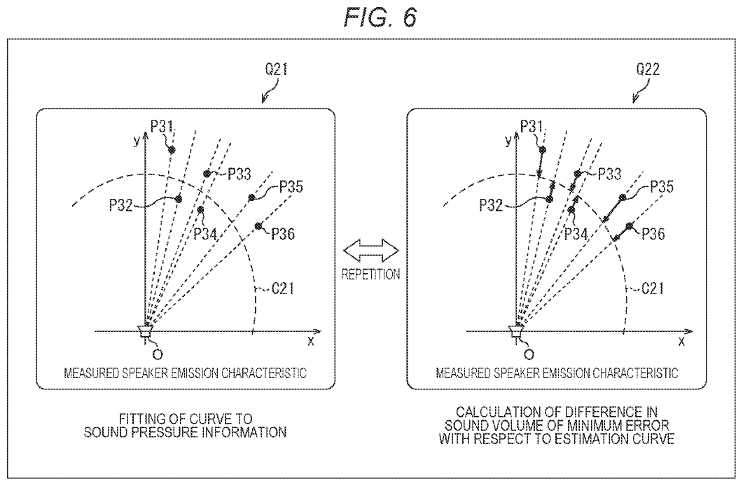

Specifically, for example, it is supposed that a result indicated by an arrow Q21 in FIG. 6 is acquired as a mapping result of each acoustic characteristic data dₙₘ, to the emission characteristic coordinate system.

In this example, positions P31 to P36 in a two-dimensional xy coordinate system as the emission characteristic coordinate system indicate positions at which pieces of sound pressure information of six acoustic characteristic data dₙₘ different from one another are mapped, respectively.

Here, the speaker emission characteristic of the speaker 21 is estimated on the basis of arrangement of the positions P31 to P36.

For example, on the basis of the positions P31 to P36, the speaker emission characteristic is estimated by performing fitting to a simple curve (fitting curve) such as an ellipse, a parabola, or any other quadratic curve with respect to the positions thereof, that is, the sound pressure information of the acoustic characteristic data dₙₘ.

At the time of fitting, for example, a parameter such as a coefficient of spherical harmonic function expansion indicating the fitting curve approximating the mapping result of the sound pressure information of the acoustic characteristic data dₙₘ, that is, a sound pressure information group of the acoustic characteristic data dₙₘ on the emission characteristic coordinate system is estimated. That is, the parameter of the fitting curve indicating the speaker emission characteristic is estimated. Then, the fitting curve acquired by the estimation is set as the speaker emission characteristic.

It is supposed that, as a result of such fitting, for example, the speaker emission characteristic indicated by a curve C21 is acquired.

Then, next, as indicated by an arrow Q22, on the basis of the speaker emission characteristic acquired by the estimation and the positions P31 to P36 acquired by the mapping, the sound volume difference from the speaker emission characteristic, that is, the difference in sound pressure is acquired for each of the positions P31 to P36 as in the case of FIG. 5. That is, the sound volume difference is acquired for each direction as seen from the origin O.

Then, the sound pressure information indicated by each of the positions P31 to P36, that is, the mapping result of the sound pressure information is corrected so that a sound pressure error from the speaker emission characteristic indicated by the sound volume (sound pressure) difference, for example, the sum and square-sum of the sound pressure differences at the positions P31 to P36 are minimized.

Here, the mapping result corrected in this manner, that is, the corrected sound pressure information regarding each acoustic characteristic data drin, is particularly referred to as corrected sound pressure information.

When the corrected sound pressure information is acquired in this manner, thereafter, estimation processing of estimating the speaker emission characteristic on the basis of the corrected sound pressure information as in the example indicated by the arrow Q21 and sound pressure correction processing of further correcting the corrected sound pressure information so as to minimize the sound pressure error as in the example indicated by the arrow Q22 on the basis of the estimation result are iteratively and repeatedly performed.

Such estimation processing and sound pressure correction processing are repeatedly performed until the sound pressure error with respect to the speaker emission characteristic of the corrected sound pressure information converges, that is, until a predetermined convergence condition is satisfied.

For example, the convergence condition (termination condition) of the repeatedly performed estimation processing and sound pressure correction processing may be the time when the sound pressure error becomes equal to or smaller than a certain value (threshold), when a change in parameter of the fitting curve for estimating the speaker emission characteristic becomes equal to or smaller than a certain value and the like.

When the convergence condition is satisfied, a difference between the corrected sound pressure information of the speaker 21 acquired at that time and the sound pressure information indicated by the acoustic characteristic data dₙₘ is acquired as an estimation result of final sound volume variation of the speaker 21. In other words, a difference between the acoustic characteristic data dₙₘ in each direction and a final speaker emission characteristic (fitting curve) acquired by the estimation is acquired as the estimation result of the sound volume variation. Then, the correction data for correcting the sound volume variation of each speaker 21 is generated on the basis of the acquired estimation result of the sound volume variation.

As described above, in the present technology, even in a case where the speaker emission characteristic of the speaker 21 is unknown, the speaker emission characteristic may be estimated, and the sound volume variation of each speaker 21 may be estimated using the estimation result.

<Configuration Example of Measurement System>

Next, a configuration and an operation of a measurement system to which the present technology described above is applied are described.

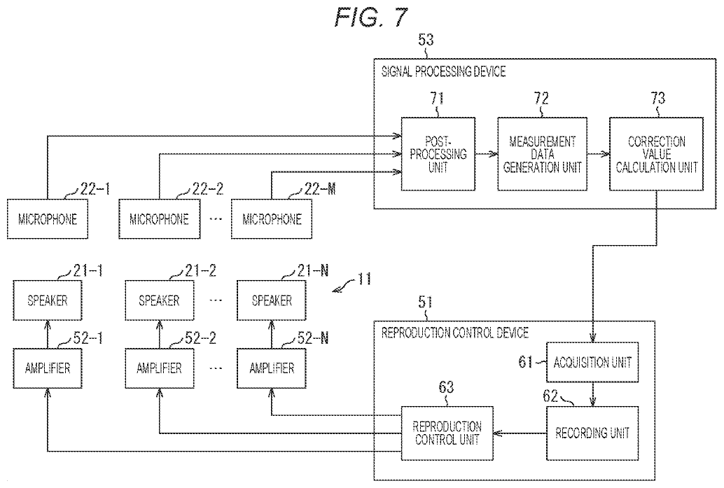

The measurement system to which the present technology is applied is formed as illustrated in FIG. 7, for example. Note that, in FIG. 7, the same reference sign is assigned to a portion corresponding to that in FIG. 2 and the description thereof is appropriately omitted.

The measurement system illustrated in FIG. 7 includes a reproduction control device 51, amplifiers 52-1 to 52-N, the speaker array 11, the microphones 22-1 to 22-M, and a signal processing device 53.

In particular, in this example, the reproduction control device 51, the amplifiers 52-1 to 52-N, and the speaker array 11 are configured for reproducing a desired sound of a content and the like as the reproduction signal. Note that, the speaker array 11 may be any speaker array such as a linear speaker array or an annular speaker array.

The reproduction control device 51 supplies the speaker drive signal for reproducing the desired sound to the speakers 21-1 to 21-N forming the speaker array 11 via the amplifiers 52-1 to 52-N, respectively, and causes the speaker array 11 to output the desired sound.

The amplifiers 52-1 to 52-N amplify the speaker drive signal supplied from the reproduction control device 51 to supply to the speakers 21-1 to 21-N, respectively.

Note that, hereinafter, in a case where it is not necessary to particularly distinguish the amplifiers 52-1 to 52-N from one another, they are sometimes simply referred to as the amplifiers 52.

In this example, since the amplifier 52 is provided on a preceding stage of the speaker 21 for each speaker 21, variation occurs in the sound volume of the sound output from each speaker 21 depending on the characteristic, sound volume setting and the like of each amplifier 52. Moreover, the sound volume variation also occurs due to a difference in frequency characteristic of each speaker 21 and the like.

Therefore, it is necessary to generate the correction data for each speaker 21 and correct the sound volume variation when the content and the like are reproduced.

The reproduction control device 51 includes an acquisition unit 61, a recording unit 62, and a reproduction control unit 63.

The acquisition unit 61 acquires the correction data for correcting the sound volume variation of each speaker 21 from the signal processing device 53 and supplies the same to the recording unit 62.

The recording unit 62 records the correction data supplied from the acquisition unit 61, and also records in advance the audio signal of the content and the like, a sound field control filter for the sound field control, more specifically, a filter coefficient of the sound field control filter and the like.

The reproduction control unit 63 reads the audio signal, the filter coefficient, the correction data and the like from the recording unit 62 as necessary, generates the speaker drive signal, and supplies the same to the amplifier 52.

In contrast, the microphone 22 and the signal processing device 53 are configured for measuring the sound volume variation of the speaker 21 and generating the correction data, and the microphone 22 and the signal processing device 53 are not used when reproducing the content and the like.

Therefore, after the correction data is acquired, it is sufficient that only the speaker array 11, the amplifier 52, and the reproduction control device 51 are installed.

In the measurement system, the M microphones 22 are arranged at the desired M measurement points (measurement positions), respectively.

The signal processing device 53 generates the correction data of each speaker 21 on the basis of the recorded sound data supplied from the microphone 22, and supplies the same to the reproduction control device 51.

The signal processing device 53 includes a post-processing unit 71, a measurement data generation unit 72, and a correction value calculation unit 73.

The post-processing unit 71 performs the post-processing on the recorded sound data supplied from each microphone 22, and supplies the recorded sound data subjected to the post-processing to the measurement data generation unit 72.

The measurement data generation unit 72 generates the measurement data on the basis of the recorded sound data supplied from the post-processing unit 71 and the measurement angle θₙₘ and the measurement distance rₙₘ input by a user and the like in advance, and supplies the same to the correction value calculation unit 73.

On the basis of the measurement data supplied from the measurement data generation unit 72, the correction value calculation unit 73 calculates the correction data of the sound volume variation of each speaker 21, that is, a gain correction value for correcting the gain of the speaker drive signal, and supplies the acquired correction data to the acquisition unit 61.

Note that, although an example in which the correction data is generated using the M microphones 22 is described here, the correction data may also be generated using one microphone 22.

In such a case, the microphone 22 measures (collects) the test signal at each measurement point while the installation position of the microphone 22 is moved to the desired measurement point. In a case where only one microphone 22 is used in this manner, variation in characteristic does not occur between a plurality of microphones 22, so that more accurate correction data may be acquired.

<Description of Measurement Processing>

Subsequently, the operation of the measurement system illustrated in FIG. 7 is described.

Note that, here, a case where the speaker emission characteristic of the speaker 21 is known and the speaker emission characteristic information is acquired in advance is described.

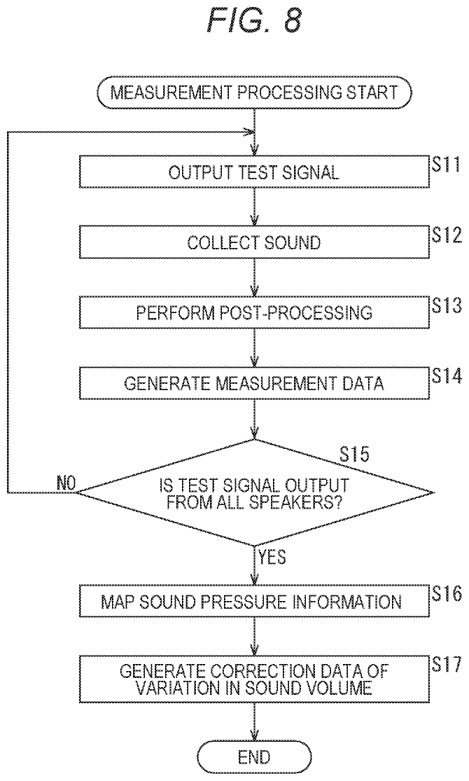

In a case where the correction data of the sound volume variation is generated for each speaker 21, the measurement system performs the measurement processing illustrated in FIG. 8. That is, the measurement processing by the measurement system is hereinafter described with reference to a flowchart in FIG. 8.

When the measurement processing is started, the speaker 21 outputs the test signal at step S11.

That is, the reproduction control unit 63 reads the audio signal for reproducing the test signal from the recording unit 62, and selects one of the N speakers 21 forming the speaker array 11 as the speaker 21 to be processed.

Then, the reproduction control unit 63 uses the read audio signal as it is as the speaker drive signal, and supplies the speaker drive signal to the speaker 21 to be processed via the amplifier 52. Then, the speaker 21 to be processed outputs (reproduces) the sound as the test signal on the basis of the speaker drive signal supplied from the reproduction control unit 63 via the amplifier 52.

At step S12, the M microphones 22 collect the test signal output from the speaker 21 to be processed and supply the recorded sound data acquired as a result to the post-processing unit 71.

At step S13, the post-processing unit 71 performs the post-processing on the recorded sound data supplied from each microphone 22, and supplies the recorded sound data acquired as a result to the measurement data generation unit 72. For example, at step S13, as described with reference to FIG. 3, the cutout processing based on the cutout window is performed as the post-processing.

At step S14, the measurement data generation unit 72 generates the measurement data on the basis of the recorded sound data subjected to the post-processing supplied from the post-processing unit 71 and the known measurement angle θₙₘ and measurement distance rₙₘ, and supplies the same to the correction value calculation unit 73.

At step S14, the measurement data including the acoustic characteristic data dₙₘ, the microphone position information, and the speaker direction information is generated.

Furthermore, the correction processing of the distance attenuation on the acoustic characteristic data dₙₘ is performed on the basis of the microphone position information, that is, the measurement distance rₙₘ. This correction processing may be performed when generating the measurement data by the measurement data generation unit 72, or may be performed when generating the correction data by the correction value calculation unit 73.

At step S15, the signal processing device 53 determines whether or not the test signal is output while setting all the speakers 21 as the speakers 21 to be processed.

In a case where it is determined at step S15 that the test signal is not yet output while setting all the speakers 21 as the speakers 21 to be processed, the procedure returns to step S11, and the above-described processing is repeatedly performed.

In contrast, in a case where it is determined at step S15 that the test signal is output while setting all the speakers 21 as the speakers 21 to be processed, the procedure then shifts to step S16.

In this case, the measurement data including the acoustic characteristic data is acquired for all the combinations of the microphone 22 and the speaker 21.

At step S16, the correction value calculation unit 73 maps the sound pressure information indicated by the acoustic characteristic data on the emission characteristic coordinate system as described with reference to FIG. 4 on the basis of the measurement data supplied from the measurement data generation unit 72.

Furthermore, the correction value calculation unit 73 also maps the speaker emission characteristic indicated by the speaker emission characteristic information on the emission characteristic coordinate system on the basis of the speaker emission characteristic information held in advance. Therefore, for example, the mapping result illustrated in FIG. 5 is acquired.

At step S17, the correction value calculation unit 73 acquires the difference between the sound pressure information of the acoustic characteristic data and the sound pressure indicated by the speaker emission characteristic on the basis of the mapping result acquired at step S16, and generates the correction data of the sound volume variation of each speaker 21 on the basis of the difference.

For example, at step S17, as described with reference to FIG. 5, the difference between the sound pressure information of the acoustic characteristic data and the sound pressure indicated by the speaker emission characteristic is acquired as the sound volume variation for each direction as seen from the origin O on the emission characteristic coordinate system.

Then, for each speaker 21, the correction data for correcting the sound volume variation of the speaker 21 is calculated on the basis of the estimation result of the acquired difference, that is, the sound volume variation.

The correction value calculation unit 73 supplies the correction data of each speaker 21 acquired in this manner to the acquisition unit 61 of the reproduction control device 51. Then, the acquisition unit 61 supplies the correction data supplied from the correction value calculation unit 73 to the recording unit 62 to cause the same to record the correction data.

When the correction data of each speaker 21 is recorded in the recording unit 62 in this manner, the measurement processing ends.

As described above, the measurement system maps the sound pressure information indicated by the acoustic characteristic data on the emission characteristic coordinate system on the basis of the measurement data acquired by measuring the sound pressure at the position of each microphone 22, and generates the correction data of each speaker 21.

In this manner, it is possible to easily acquire the estimation result of the characteristic, that is, the sound volume variation of a plurality of speakers 21 with a smaller number of times of installation and movement of the microphone 22, and as a result, it is possible to more easily acquire the correction data of each speaker 21.

Furthermore, when the correction data of each speaker 21 is acquired, the sound volume variation is corrected on the basis of the correction data when reproducing the content and the like.

For example, it is supposed that, on the basis of an audio signal of a predetermined content recorded in the recording unit 62, the sound of the content is reproduced.

In such a case, the reproduction control unit 63 reads the audio signal of the content, the filter coefficient of the sound field control filter, and the correction data of each speaker 21 from the recording unit 62.

Then, the reproduction control unit 63 performs convolution processing of the audio signal of the content and the filter coefficient of the sound field control filter to generate the speaker drive signal of each speaker 21 for implementing the sound field control such as wavefront synthesis and local reproduction.

Moreover, for each speaker 21, the reproduction control unit 63 performs the gain correction based on the correction data on the speaker drive signal of the speaker 21 as correction processing of the sound volume variation based on the correction data, and generates a final speaker drive signal.

The reproduction control unit 63 supplies the speaker drive signal for each speaker 21 acquired in this manner to the speaker 21 via the amplifier 52, and causes the speaker 21 to output the sound based on the speaker drive signal as the reproduction signal. Therefore, the sound volume variation between the speakers 21 is corrected and more accurate sound field control is implemented.

### Second Embodiment

<Description of Measurement Processing>

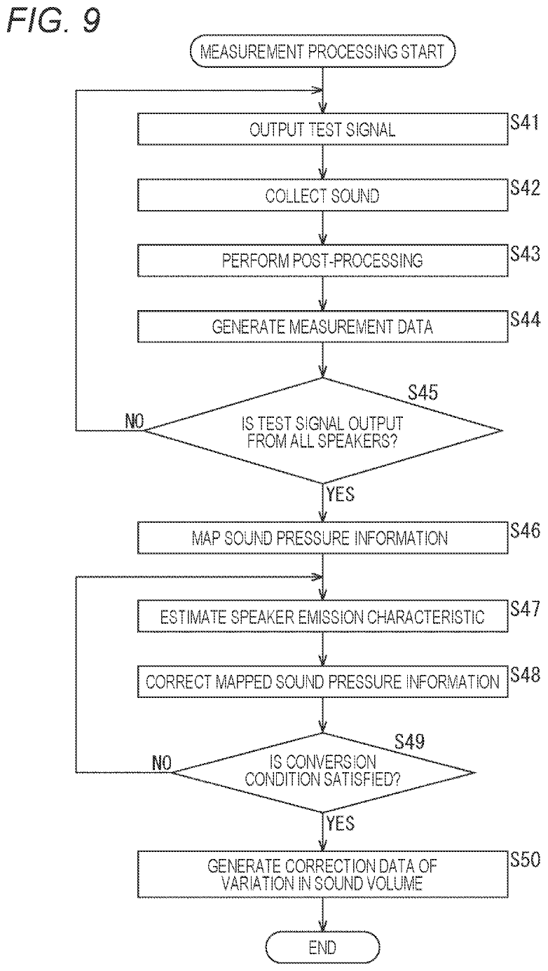

Furthermore, a case where a speaker emission characteristic is known is described with reference to FIG. 8; however, a measurement system performs measurement processing illustrated in FIG. 9 in a case where the speaker emission characteristic is unknown.

Hereinafter, the measurement processing by the measurement system is described with reference to a flowchart in FIG. 9. Note that, processing at steps S41 to S46 is similar to that at steps S11 to S16 in FIG. 8, the description thereof is appropriately omitted. However, at step S46, since the speaker emission characteristic is unknown, mapping of the speaker emission characteristic is not performed.

At step S47, a correction value calculation unit 73 estimates the speaker emission characteristic on the basis of a mapping result at step S46.

Here, for example, as described with reference to FIG. 6, the correction value calculation unit 73 estimates the speaker emission characteristic by estimating a parameter indicating a fitting curve on the basis of sound pressure information of acoustic characteristic data.

At step S48, the correction value calculation unit 73 corrects each mapped sound pressure information so that a sound pressure error from the speaker emission characteristic is minimized on the basis of the speaker emission characteristic acquired by estimation, and calculates corrected sound pressure information. Here, for example, the corrected sound pressure information is calculated as described with reference to FIG. 6.

At step S49, the correction value calculation unit 73 determines whether or not a convergence condition is satisfied.

For example, at step S49, as described with reference to FIG. 6, it is determined that the convergence condition is satisfied in a case where the sound pressure error becomes equal to or smaller than a certain value or in a case where a change in parameter of a fitting curve becomes equal to or smaller than a certain value.

In a case where it is determined that the convergence condition is not yet satisfied at step S49, the procedure returns to step S47 and the above-described processing is repeatedly performed. That is, the speaker emission characteristic is estimated on the basis of the corrected sound pressure information acquired most recently, and the corrected sound pressure information is further corrected on the basis of the estimation result.

In contrast, in a case where it is determined that the convergence condition is satisfied at step S49, the procedure thereafter shifts to step S50.

At step S50, the correction value calculation unit 73 acquires a difference between the corrected sound pressure information acquired finally and the sound pressure information of the acoustic characteristic data as an estimation result of final sound volume variation, and generates correction data of the sound volume variation of each speaker 21 on the basis of the difference.

The correction value calculation unit 73 supplies the correction data of each speaker 21 acquired in this manner to an acquisition unit 61 of a reproduction control device 51, and the acquisition unit 61 supplies the correction data supplied from the correction value calculation unit 73 to the recording unit 62 and causes the same to record the correction data.

When the correction data of each speaker 21 is recorded in the recording unit 62 in this manner, the measurement processing ends.

As described above, the measurement system estimates the speaker emission characteristic on the basis of measurement data acquired by measuring a sound pressure at a position of each microphone 22, and generates the correction data of each speaker 21 on the basis of the estimation result.

In this manner also, as in a case where the speaker emission characteristic is known, a characteristic of the speaker 21 such as the sound volume variation and the speaker emission characteristic may be estimated more easily, and the correction data of each speaker 21 may be acquired.

<Configuration Example of Computer>

Note that, the above-described series of processes may be executed by hardware or by software. In a case where a series of processes is executed by the software, a program that forms the software is installed on a computer. Here, the computer includes a computer built in dedicated hardware, a general-purpose personal computer, for example, capable of executing various functions by various programs installed and the like.

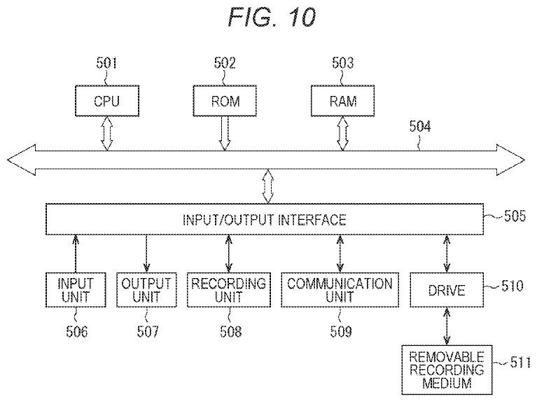

FIG. 10 is a block diagram illustrating a configuration example of the hardware of the computer that executes the above-described series of processes by the program.

In the computer, a central processing unit (CPU) 501, a read only memory (ROM) 502, and a random access memory (RAM) 503 are connected to one another through a bus 504.

An input/output interface 505 is further connected to the bus 504. An input unit 506, an output unit 507, a recording unit 508, a communication unit 509, and a drive 510 are connected to the input/output interface 505.

The input unit 506 includes a keyboard, a mouse, a microphone, an imaging element and the like. The output unit 507 includes a display, a speaker and the like. The recording unit 508 includes a hard disk, a non-volatile memory and the like. The communication unit 509 includes a network interface and the like. The drive 510 drives a removable recording medium 511 such as a magnetic disk, an optical disk, a magnetooptical disk, or a semiconductor memory.

In the computer configured in the above-described manner, the CPU 501 loads the program recorded in the recording unit 508, for example, on the RAM 503 through the input/output interface 505 and the bus 504 to execute, and as a result, the above-described series of processes is performed.

The program executed by the computer (CPU 501) may be recorded in the removable recording medium 511 as a package medium and the like to be provided, for example. Furthermore, the program may be provided by means of a wired or wireless transmission medium such as a local area network, the Internet, and digital broadcasting.

In the computer, the program may be installed on the recording unit 508 through the input/output interface 505 by mounting the removable recording medium 511 on the drive 510. Furthermore, the program may be received by the communication unit 509 through the wired or wireless transmission medium to be installed on the recording unit 508. In addition, the program may be installed in advance on the ROM 502 and the recording unit 508.

Note that, the program executed by the computer may be the program of which processing is performed in chronological order in the order described in this specification or may be the program of which processing is performed in parallel or at required timing such as when a call is issued.

Furthermore, the embodiment of the present technology is not limited to the above-described embodiments and various modifications may be made without departing from the gist of the present technology.

For example, the present technology may be configured as cloud computing in which one function is shared by a plurality of devices via the network to process together.

Furthermore, each step described in the above-described flowchart may be executed by one device or executed by a plurality of devices in a shared manner.

Moreover, in a case where a plurality of processes is included in one step, the plurality of processes included in one step may be executed by one device or by a plurality of devices in a shared manner.

Moreover, the present technology may also have a following configuration.

(1)

A signal processing device including:
a correction value calculation unit configured to calculate, for every plurality of speakers having substantially the same emission characteristic, the speakers forming a speaker array, a gain correction value of each of the speakers on the basis of acoustic characteristic data acquired by collecting a sound from the speakers at a plurality of measurement points and the emission characteristic.

(2)

The signal processing device according to (1), in which
the correction value calculation unit calculates the gain correction value on the basis of position information indicating a position of a measurement point, direction information indicating a direction of the measurement point as seen from the speaker, the acoustic characteristic data, and the emission characteristic.

(3)

The signal processing device according to (1) or (2), in which
the correction value calculation unit estimates the emission characteristic on the basis of the acoustic characteristic data, and calculates the gain correction value on the basis of the emission characteristic acquired by estimation and the acoustic characteristic data.

(4)

The signal processing device according to (3), in which
the correction value calculation unit maps the acoustic characteristic data on an emission characteristic coordinate system, and estimates the emission characteristic by estimating a parameter of a curve indicating the emission characteristic on the basis of a mapping result.

(5)

The signal processing device according to (4), in which
the curve is a parabola or an ellipse.

(6)

The signal processing device according to (4) or (5), in which
the correction value calculation unit calculates the gain correction value by acquiring a difference between the acoustic characteristic data and the emission characteristic on the emission characteristic coordinate system.

(7)

The signal processing device according to (6), in which
the emission characteristic coordinate system is a coordinate system in which a direction as seen from an origin indicates a direction as seen from the speaker, and a distance from the origin indicates magnitude of sound pressure information.

(8)

The signal processing device according to (7), in which
the correction value calculation unit calculates the gain correction value by acquiring the difference between the acoustic characteristic data and the emission characteristic for each direction as seen from the origin on the emission characteristic coordinate system.

(9)

The signal processing device according to (1) or (2), in which
the correction value calculation unit maps the acoustic characteristic data on the emission characteristic coordinate system, and calculates the gain correction value by acquiring a difference between the acoustic characteristic data and the emission characteristic on the emission characteristic coordinate system.

(10)

The signal processing device according to (2), in which
the direction information is an angle indicating a direction of the measurement point with respect to a front direction of the speaker, and
the position information includes a distance between the speaker and the measurement point, and the angle.

(11)

A signal processing method including:
by a signal processing device,
calculating, for every plurality of speakers having substantially the same emission characteristic, the speakers forming a speaker array, a gain correction value of each of the speakers on the basis of acoustic characteristic data acquired by collecting a sound from the speakers at a plurality of measurement points and the emission characteristic.

(12)

A program that causes a computer to execute processing including:
calculating, for every plurality of speakers having substantially the same emission characteristic, the speakers forming a speaker array, a gain correction value of each of the speakers on the basis of acoustic characteristic data acquired by collecting a sound from the speakers at a plurality of measurement points and the emission characteristic.

### REFERENCE SIGNS LIST

11 Speaker array
21-1 to 21-N, 21 Speaker
22-1 to 22-M, 22 Microphone
51 Reproduction control device
53 Signal processing device
63 Reproduction control unit
71 Post-processing unit
72 Measurement data generation unit
73 Correction value calculation unit

1. A signal processing device comprising:
a correction value calculation unit configured to calculate, for every plurality of speakers having a substantially same emission characteristic, the speakers forming a speaker array, a gain correction value of each of the speakers on a basis of acoustic characteristic data acquired by collecting a sound from the speakers at a plurality of measurement points and the emission characteristic.

2. The signal processing device according to claim 1, wherein
the correction value calculation unit calculates the gain correction value on a basis of position information indicating a position of a measurement point, direction information indicating a direction of the measurement point as seen from the speaker, the acoustic characteristic data, and the emission characteristic.

3. The signal processing device according to claim 1, wherein
the correction value calculation unit estimates the emission characteristic on a basis of the acoustic characteristic data, and calculates the gain correction value on a basis of the emission characteristic acquired by estimation and the acoustic characteristic data.

4. The signal processing device according to claim 3, wherein
the correction value calculation unit maps the acoustic characteristic data on an emission characteristic coordinate system, and estimates the emission characteristic by estimating a parameter of a curve indicating the emission characteristic on a basis of a mapping result.

5. The signal processing device according to claim 4, wherein
the curve is a parabola or an ellipse.

6. The signal processing device according to claim 4, wherein
the correction value calculation unit calculates the gain correction value by acquiring a difference between the acoustic characteristic data and the emission characteristic on the emission characteristic coordinate system.

7. The signal processing device according to claim 6, wherein
the emission characteristic coordinate system is a coordinate system in which a direction as seen from an origin indicates a direction as seen from the speaker, and a distance from the origin indicates magnitude of sound pressure information.

8. The signal processing device according to claim 7, wherein
the correction value calculation unit calculates the gain correction value by acquiring the difference between the acoustic characteristic data and the emission characteristic for each direction as seen from the origin on the emission characteristic coordinate system.

9. The signal processing device according to claim 1, wherein
the correction value calculation unit maps the acoustic characteristic data on the emission characteristic coordinate system, and calculates the gain correction value by acquiring a difference between the acoustic characteristic data and the emission characteristic on the emission characteristic coordinate system.

10. The signal processing device according to claim 2, wherein
the direction information is an angle indicating a direction of the measurement point with respect to a front direction of the speaker, and
the position information includes a distance between the speaker and the measurement point, and the angle.

11. A signal processing method comprising:
by a signal processing device,
calculating, for every plurality of speakers having a substantially same emission characteristic, the speakers forming a speaker array, a gain correction value of each of the speakers on a basis of acoustic characteristic data acquired by collecting a sound from the speakers at a plurality of measurement points and the emission characteristic.

12. A program that causes a computer to execute processing comprising:
calculating, for every plurality of speakers having a substantially same emission characteristic, the speakers forming a speaker array, a gain correction value of each of the speakers on a basis of acoustic characteristic data acquired by collecting a sound from the speakers at a plurality of measurement points and the emission characteristic.
